(19) United States
(12) Patent Application Publication
(10) Pub. No.: US 2011/0307204 A1
(43) Pub. Date: Dec. 15, 2011

(54) VELOCITY MEASURING DEVICE AND METHOD FOR CORRECTING MEASURED VELOCITY

(76) Inventor: Sung-Yeob CHO, Seoul (KR)

(21) Appl. No.: 12/950,485

(22) Filed: Nov. 19, 2010

(30) Foreign Application Priority Data
Jun. 9, 2010 (KR) 10-2010-0054313

(51) Int. Cl. G06F 19/00; G01P 21/00; G01P 11/00

(52) U.S. Cl. 702/96; 702/149

(57) ABSTRACT

A velocity measuring device and a measured velocity correcting method are provided. The velocity measuring device includes: a GPS unit that receives a satellite signal from a GPS (Global Positioning System) satellite and generates GPS data including position coordinates and a traveling velocity; an acceleration sensor unit that includes an acceleration sensor and generates sensor data including a traveling velocity and a road slope; and a correction unit that compares the GPS data and the sensor data generated at a current time with the GPS data and the sensor data generated at a previous time and sets the traveling velocity included in the sensor data or the GPS data as a measured velocity depending on whether a variation in traveling velocity exists.

### CROSS REFERENCE

This application is based on and claims priority under 35USC 119 from Korean Patent Application No. 10-2010-0054313, filed on Jun. 9, 2010.

### BACKGROUND

1. Field of the Invention

The present invention relates to a velocity measuring device and a measured velocity correcting method.

2. Description of the Related Art

Recently, a GPS (Global Positioning System) has been more and more used to acquire information on a vehicle's traveling. The GPS technique is widely used in various electronic apparatuses (such as a navigation apparatus, a vehicle black box, and a mobile communication terminal) regardless of designations thereof.

A velocity measuring device (for example, a navigation or a vehicle black box) mounted on a vehicle leads a driver to safely drive by measuring a vehicle traveling velocity using the GPS technique and displaying the measured velocity on a screen.

However, the traveling velocity displayed by the velocity measuring device is often different from the traveling velocity displayed by a vehicle speedometer.

FIG. 1A is a diagram illustrating a time-difference error between an actual vehicle traveling velocity and a velocity measured by the velocity measuring device and FIG. 1B is a diagram illustrating an error between an actual vehicle traveling velocity and a velocity measured by the velocity measuring device when a vehicle travels along a slope.

As shown in FIGS. 1A and 1B, the velocity output from the velocity measuring device has a time difference of about 2 or 3 seconds, and a display interval of the velocities is about 1 second which is a slow response speed. In addition, since the velocity is not a velocity in a three-dimensional space but a velocity in a two-dimensional space, the traveling velocity displayed by the velocity measuring device is different from the actual vehicle traveling velocity.

In this way, the velocity measuring device causes a time-difference error in providing current velocity information at the time of accelerating and decelerating a vehicle. When a vehicle travels in a slope section of a road, the velocity measuring device measures and displays a velocity by assuming that the vehicle travels in a distance of a two-dimensional plane instead of an actual traveling distance in a three-dimensional space of the slope plane (with a height difference) of the road, thereby causing a velocity error.

Accordingly, a driver cannot see an accurate vehicle traveling velocity at a current time, which causes an misapprehension in the vehicle traveling velocity. In addition, a variety of information (for example, a speed alarm) using the velocity is based on inaccurate information.

The above-mentioned related art is technical information possessed to make the invention or learned in the course of making the invention by the inventor, and cannot thus be said to be technical information known to the public before filing the invention.

### SUMMARY

An advantage of some aspects of the invention is that it provides a velocity measuring device and a measured velocity correcting method, which can accurately measure a velocity in spite of an output time difference (for example, about 2 or 3 seconds) of measured traveling velocity information, a slow response speed (for example, a velocity display interval of about 1 second), and an inaccurate traveling path (for example, a slope).

Another advantage of some aspects of the invention is that it provides a velocity measuring device and a measured velocity correcting method, which can provide a velocity more accurately and rapidly than the known velocity measuring device by additionally utilizing an acceleration sensor and the like.

Another advantage of some aspects of the invention is that it provides a velocity measuring device and a measured velocity correcting method, which can display a velocity variation to correspond to the minimum unit of images stored in a memory by providing a velocity more accurately and rapidly.

Other advantages of the invention will be easily understood from the following description.

According to an aspect of the invention, there is provided a velocity measuring device including: a GPS unit that receives a satellite signal from a GPS (Global Positioning System) satellite and generates GPS data including position coordinates and a traveling velocity; an acceleration sensor unit that includes an acceleration sensor and generates sensor data including a traveling velocity and a road slope; and a correction unit that compares the GPS data and the sensor data generated at a current time with the GPS data and the sensor data generated at a previous time and sets the traveling velocity included in the sensor data or the GPS data as a measured velocity depending on whether a variation in traveling velocity exists.

The correction unit may compare the GPS data and the sensor data generated at a current time with the GPS data and the sensor data generated at a previous time, set the traveling velocity included in the sensor data as the measured velocity when a variation in traveling velocity exists in one or more of the GPS data and the sensor data, and set the traveling velocity included in the GPS data as the measured velocity when a variation in traveling velocity does not exist.

The velocity measuring device may further include a storage unit that stores road slope correction ratios, and the correction unit may calculate the measured velocity by reading the correction ratio corresponding to the road slope included in the sensor data from the storage unit and applying the read correction ratio to the traveling velocity included in the GPS data.

The correction unit may correct an offset value of the acceleration sensor when one or more of the position coordinates and the traveling velocity included in the GPS data do not vary for a predetermined time.

The correction operation of the correction unit may include making the average of the traveling velocities in a predetermined number of generated sensor data be 0 (zero).

According to another aspect of the invention, there is provided a velocity measuring device including: a GPS unit that receives a satellite signal from a GPS (Global Positioning System) satellite and generates GPS data including position coordinates and a traveling velocity; an acceleration sensor unit that includes an acceleration sensor and generates sensor data including a traveling velocity and a road slope; and a correction unit that corrects an offset value of the acceleration sensor when one or more of the position coordinates and the traveling velocity included in the GPS data do not vary for a predetermined time.

The correction operation of the correction unit may include making the average of the traveling velocities in a predetermined number of generated sensor data be 0 (zero).

The correction unit may compare the GPS data and the sensor data generated at a current time with the GPS data and the sensor data generated at a previous time, set the traveling velocity included in the sensor data as the measured velocity when a variation in traveling velocity exists in one or more of the GPS data and the sensor data, and set the traveling velocity included in the GPS data as the measured velocity when a variation in traveling velocity does not exist.

The velocity measuring device may further include a storage unit that stores road slope correction ratios, and the correction unit may calculate the measured velocity by reading the correction ratio corresponding to the road slope included in the sensor data from the storage unit and applying the read correction ratio to the traveling velocity included in the GPS data.

According to another aspect of the invention, there is provided a measured velocity correcting method carried out by a velocity measuring device, including the steps of receiving a satellite signal from a GPS (Global Positioning System) satellite, generating GPS data including position coordinates and a traveling velocity, and generating sensor data including a traveling velocity and a road slope by the use of an acceleration sensor; comparing the GPS data and the sensor data generated at a current time with the GPS data and the sensor data generated at a previous time and determining whether a variation in traveling velocity exists; and setting the traveling velocity included in the sensor data as the measured velocity when a variation in traveling velocity exists in one or more of the GPS data and the sensor data and setting the traveling velocity included in the GPS data as the measured velocity when a variation in traveling velocity does not exist.

The measured velocity correcting method may further include a step of correcting the measured velocity by reading the correction ratio corresponding to the road slope included in the sensor data from the storage unit and applying the read correction ratio to the traveling velocity included in the GPS data.

The measured velocity correcting method may further include the steps of determining whether one or more of the position coordinates and the traveling velocity included in the GPS data vary for a predetermined time; and correcting an offset value of the acceleration sensor when it is determined that one or more of the position coordinates and the traveling velocity included in the GPS data do not vary for a predetermined time.

The step of correcting an offset value may include making the average of the traveling velocities in a predetermined number of generated sensor data be 0 (zero).

According to another aspect of the invention, there is provided a measured velocity correcting method carried out by a velocity measuring device, including the steps of receiving a satellite signal from a GPS (Global Positioning System) satellite, generating GPS data including position coordinates and a traveling velocity, and generating sensor data including a traveling velocity and a road slope by the use of an acceleration sensor; determining whether one or more of the position coordinates and the traveling velocity included in the GPS data vary for a predetermined time; and correcting an offset value of the acceleration sensor when it is determined that one or more of the position coordinates and the traveling velocity included in the GPS data do not vary for a predetermined time.

The step of correcting an offset value may include making the average of the traveling velocities in a predetermined number of generated sensor data be 0 (zero).

The measured velocity correcting method may further include the steps of comparing the GPS data and the sensor data generated at a current time with the GPS data and the sensor data generated at a previous time and determining whether a variation in traveling velocity exists; and setting the traveling velocity included in the sensor data as the measured velocity when a variation in traveling velocity exists in one or more of the GPS data and the sensor data and setting the traveling velocity included in the GPS data as the measured velocity when a variation in traveling velocity does not exist.

The measured velocity correcting method may further include a step of correcting the measured velocity by reading the correction ratio corresponding to the road slope included in the sensor data from the storage unit and applying the read correction ratio to the traveling velocity included in the GPS data.

Other aspects, features, and advantages will become apparent from the accompanying drawings, the appended claims, and the detailed description.

According to the above-mentioned configurations of the invention, it is possible to accurately measure a velocity in spite of an output time difference (for example, about 2 or 3 seconds) of measured traveling velocity information, a slow response speed (for example, a velocity display interval of about 1 second), and an inaccurate traveling path (for example, a slope).

It is also possible to provide a velocity more accurately and rapidly than the known velocity measuring device by additionally utilizing an acceleration sensor and the like.

It is also possible to display a velocity variation to correspond to the minimum unit of images stored in a memory by providing a velocity more accurately and rapidly.

### BRIEF DESCRIPTION OF THE DRAWINGS

FIG. 1A is a diagram illustrating a time-difference error between an actual vehicle traveling velocity and a velocity measured by the velocity measuring device.

FIG. 1B is a diagram illustrating an error between an actual vehicle traveling velocity and a velocity measured by the velocity measuring device when a vehicle travels along a slope.

FIG. 2 is a diagram schematically illustrating the configuration of a velocity measuring device according to an embodiment of the invention.

FIG. 3 is a flow diagram illustrating the flow of a velocity application method with a vehicle traveling velocity according to an embodiment of the invention.

FIG. 4 is a diagram illustrating a graph used to apply a velocity with a vehicle traveling velocity according to an embodiment of the invention.

FIG. 5 is a flow diagram illustrating the flow of a method of correcting a vehicle traveling velocity with a degree of slope according to an embodiment of the invention.

FIG. 6 is a diagram illustrating a variation in traveling distance with a degree of road slope.

FIG. 7 is a flow diagram illustrating the flow of an acceleration sensor correcting method according to an embodiment of the invention.

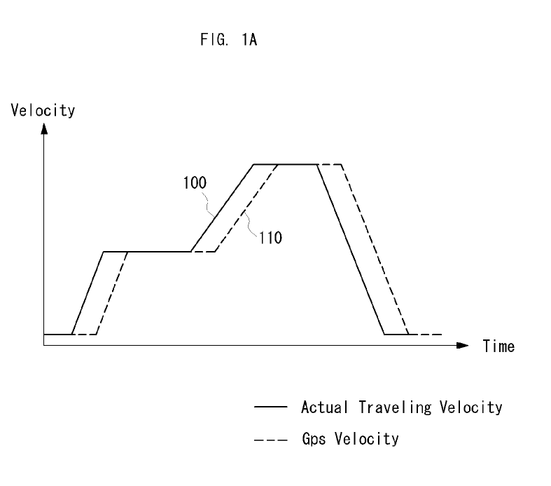

### DESCRIPTION OF EXEMPLARY EMBODIMENTS

The invention can be variously modified in various forms and specific embodiments will be described and shown in the drawings. However, the embodiments are not intended to limit the invention, but it should be understood that the invention includes all the modifications, equivalents, and replacements belonging to the spirit and the technical scope of the invention.

If it is mentioned that an element is “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

The terms used in the following description are used to merely describe specific embodiments, but are not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Terms, “unit”, “-er(-or)”, “module”, and the like, described in the specification mean a unit for performing at least one function or operation and can be embodied by hardware, by software, or by a combination of hardware and software.

In describing the invention with reference to the accompanying drawings, like elements are referenced by like reference numerals regardless of the drawing numbers and repeated description is not made. When it is determined that detailed description of known techniques associated with the invention makes the gist of the invention obscure, the detailed description will be omitted.

A velocity measuring device to which a velocity correcting method described below is applied can be embodied in various forms of electronic apparatuses such as mobile devices such as a mobile communication terminal as well as vehicle devices such as a navigation apparatus and a vehicle black box.

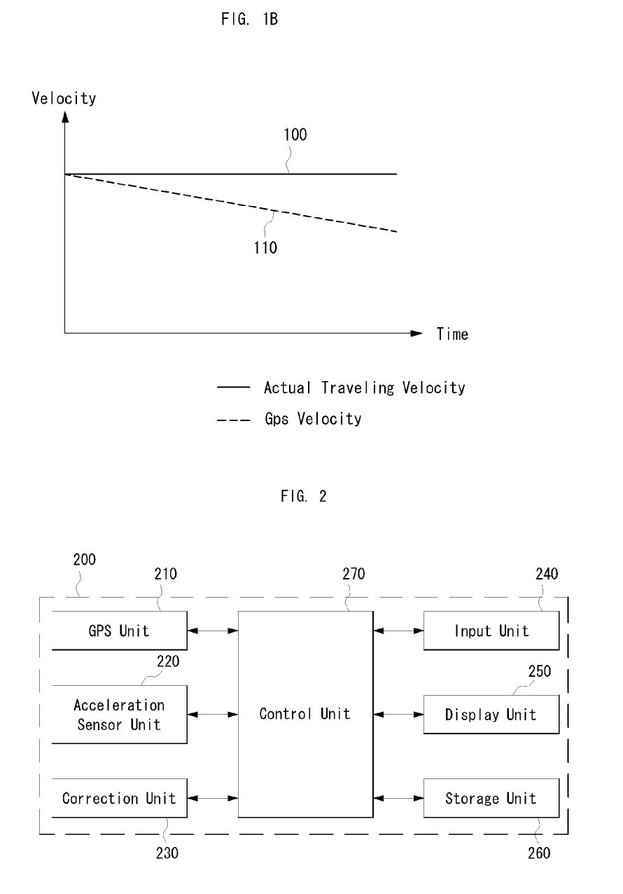

FIG. 2 is a diagram schematically illustrating the configuration of a velocity measuring device according to an embodiment of the invention.

Referring to FIG. 2, a velocity measuring device 200 includes a GPS unit 210, an acceleration sensor unit 220, a correction unit 230, an input unit 240, a display unit 250, a storage unit 260, and a control unit 270.

The GPS unit 210 receives a satellite signal from a GPS (Global Positioning System) satellite and generates GPS data including position coordinates and a traveling velocity of the velocity measuring device 200.

The acceleration sensor unit 220 generates sensor data including one or more of a vehicle traveling velocity, an acceleration, and a degree of road slope. The acceleration sensor unit 220 includes an acceleration sensor that detects the acceleration of the velocity measuring device 200, an integrator that integrates the acceleration detected by the acceleration sensor, and an operator that computes the traveling velocity of the velocity measuring device 200 by adding and subtracting the output signals of the integrator. The acceleration sensor unit 220 may further include a gyro sensor and a slope sensor for the purpose of improving the precision of the sensor data. The acceleration sensor unit 220 may have a function of measuring a degree of road slope in which the vehicle travels as described later. The method of mathematically calculating the degree of road slope using one or more of the acceleration sensor and the gyro sensor is widely known and thus is not described herein.

The correction unit 230 determines the velocity of the vehicle using the GPS data generated by the GPS unit 210 and the sensor data generated by the acceleration sensor unit 220. The correction unit 230 corrects the traveling velocity of the GPS data using the degree of road slope included in the sensor data. The correction unit 230 corrects the offset value of the acceleration sensor when the vehicle is parked or the stopped state is maintained for a predetermined time with reference to the GPS data.

The input unit 240 serves to input a command corresponding to a driver's operation. The input unit 240 may be embodied in the form of one or more buttons or in the form of a touch screen.

The display unit 250 displays information on the operating state (for example, one or more of the traveling velocity and the map information) of the velocity measuring device 200. The display unit 250 may be embodied in the form of a touch screen.

The storage unit 260 stores the GPS data generated by the GPS unit 210 and the sensor data generated by the acceleration sensor unit 220. When the velocity measuring device 200 has a function of photographing and storing an accident video as a vehicle black box, the storage unit 260 may further store the photographed video data.

The control unit 270 controls the elements of the velocity measuring device 200.

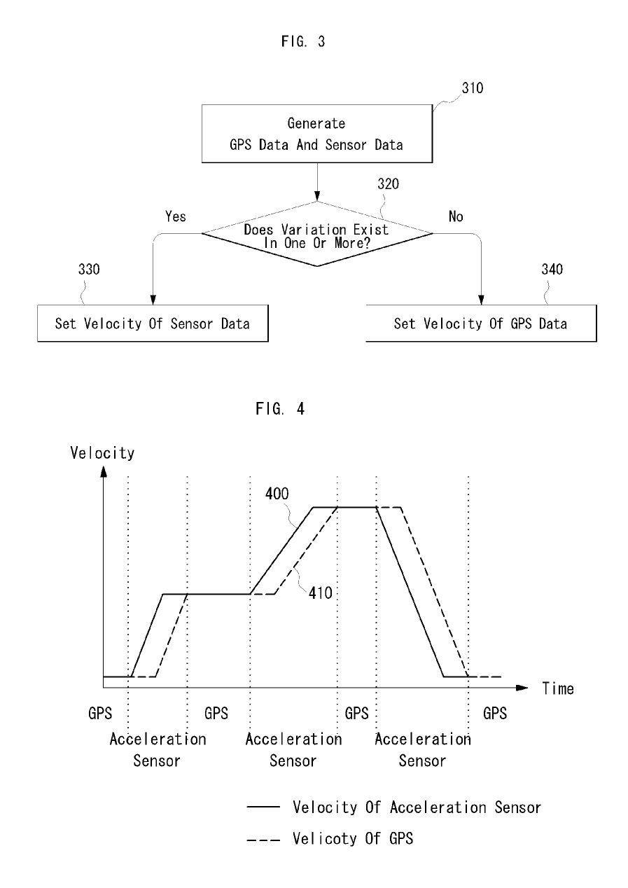

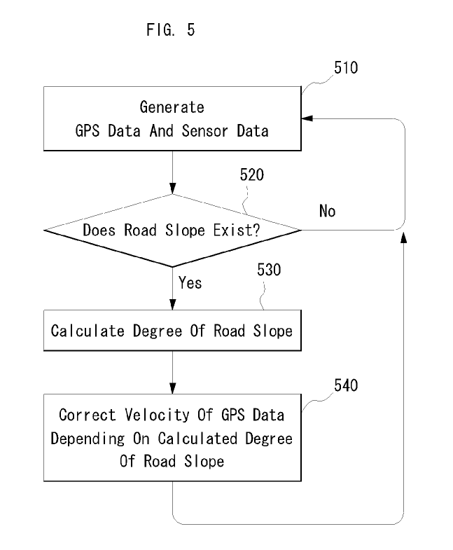

FIG. 3 is a flow diagram illustrating the flow of a velocity application method with a vehicle traveling velocity according to an embodiment of the invention. FIG. 4 is a diagram illustrating a graph used to apply a velocity with a vehicle traveling velocity according to an embodiment of the invention.

Referring to FIG. 3, in step 310, the velocity measuring device 200 generates the GPS data and the sensor data. As described above, the GPS data is generated by the GPS unit 210 and the sensor data is generated by the acceleration sensor unit 220. The GPS data includes, for example, current coordinate information and traveling velocity information and the sensor data includes, for example, one or more of acceleration (deceleration) information, traveling velocity information, and road slope information.

In step 320, the correction unit 230 determines whether a variation in traveling velocity exists in one or more of the GPS data generated by the GPS unit 210 and the sensor data generated by the acceleration sensor unit 220. For example, the correction unit 230 can determine whether the traveling velocity of the currently generated GPS data varies in comparison with the previously generated GPS data, and can determine the same for the sensor data.

When a variation in traveling velocity exists in one or more, the correction unit 230 sets the traveling velocity information included in the sensor data as the current traveling velocity of the vehicle in step 330.

When a variation in traveling velocity does not exist in one or more, the correction unit 230 sets the traveling velocity information included in the GPS data as the current traveling velocity of the vehicle in step 340.

FIG. 4 shows a velocity application graph corresponding to the traveling velocity of the vehicle.

In the drawing, reference numeral 400 represents the velocity included in the sensor data and reference numeral 410 represents the velocity included in the GPS data.

The velocities of the sensor data and the GPS data have a constant time difference, but can be drawn in an equal graph within an error range. This is because the GPS data has an insufficient real-time characteristic due to the output time difference (for example, about 2 or 3 seconds) of the measured traveling velocity information, the slow response speed (for example, a velocity display interval of about 1 second), and the like.

Accordingly, when the traveling velocities included in the sensor data and the GPS data vary in comparison with the traveling velocities in the data previously generated and stored, the correction unit 230 corrects the velocity information so as to provide the driver with more accurate velocity information based on the sensor data. However, when the traveling velocities do not vary, the correction unit 230 provides the driver with velocity information based on the GPS data.

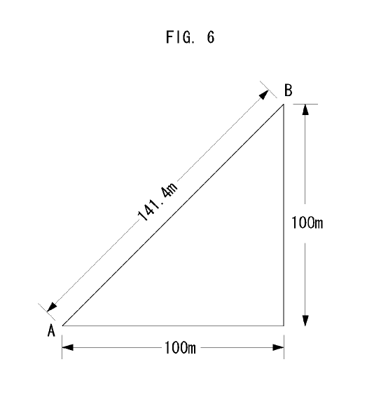

FIG. 5 is a flow diagram illustrating the flow of a method of correcting a vehicle traveling velocity with a degree of slope according to an embodiment of the invention. FIG. 6 is a diagram illustrating a variation in traveling distance with a degree of road slope.

The traveling velocity information included in the GPS data includes the velocity calculated using the traveling time from point A to point B. In this case, the road slope is not considered, thereby causing an error.

As shown in FIG. 6, when a road has a slope of 45 degrees with a horizontal distance of 100 m and a maximum height of 100 mm and a vehicle travels from point A to point B on the road, the traveling velocity of the GPS data is calculated on the basis of information that the vehicle travels 100 m, but the traveling velocity should be actually calculated on the basis of information that the vehicle travels 141.4 m.

The velocity may be three-dimensionally calculated using the height included in the GPS data. However, the height included in the GPS data has a great error and the data variation response is slow, whereby an inaccurate traveling velocity may be calculated. Therefore, there is a need for calculating an accurate traveling velocity.

Referring to FIG. 5, the velocity measuring device 200 generates the GPS data and the sensor data in step 510. As described above, the GPS data is generated by the GPS unit 210 and the sensor data is generated by the acceleration sensor unit 220.

In step 520, the correction unit 230 determines whether a road slope exists with reference to the road slope information included in the sensor data.

When the road slope does not exist, the velocity is set in step 510 as described with reference to FIG. 3

When the road slope exists, the correction unit 230 calculates the road slope in a predetermined section in step 530. The predetermined section may be designated in advance, for example, as a predetermined time (for example, 1 second) or a predetermined distance (for example, 5 m) and the road slope can be calculated as an average road slope in the section.

In step 540, the correction unit 230 corrects the traveling velocity of the GPS data on the basis of the calculated road slope. In a method of correcting the traveling velocity of the GPS data, for example, correction ratios corresponding to the road slopes may be experimentally and/or statistically designated so that the traveling velocity is corrected to increase by 10% when the degree of slope is +10 degrees, and the correction ratio corresponding to the calculated road slope may be read from the storage unit 260 and may be reflected. The corrected traveling velocity can be displayed on the display unit 250 of the velocity measuring device 200.

Hitherto, the method of correcting the traveling velocity of the GPS data on the basis of the calculated road slope has been described with reference to FIG. 5.

However, other methods of directly calculating the traveling distance of the vehicle by the use of the acceleration sensor and using the traveling distance to calculate the traveling velocity can be used.

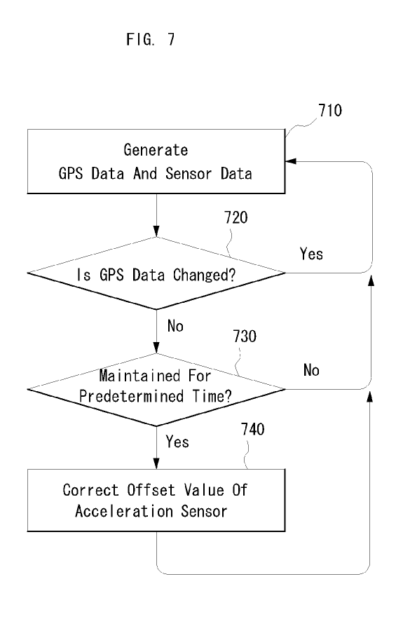

FIG. 7 is a flow diagram illustrating the flow of an acceleration sensor correcting method according to an embodiment of the invention.

In general, a variety of information such as the velocity, the distance, the slope (angle), and the traveling direction can be acquired by the use of only the acceleration sensor. However, a sensor drift phenomenon that errors are accumulated due to the temperature or inertia with the lapse of time may occur. When the sensor drift phenomenon occurs, a vehicle which does not actually travel may be displayed using only the sensor data as if it travels in a specific direction at a specific velocity, which should be corrected.

Therefore, this embodiment provides a method of removing the influence of the sensor drift phenomenon using the GPS data.

Referring to FIG. 7, the velocity measuring device 200 generates the GPS data and the sensor data in step 710. As described above, the GPS data is generated by the GPS unit 210 and the sensor data is generated by the acceleration sensor 220.

In step 720, the correction unit 230 determines whether the GPS data generated in step 710 varies in comparison with the previously generated GPS data. At this time, one or more of the position coordinate information and the traveling velocity information included in the GPS data can be used.

When a comparison factor (for example, one or more of the position coordinate information and the traveling velocity information) of the GPS data does not vary (for example, when the vehicle travels at a constant velocity or is parked), the correction unit 230 determines whether the corresponding state is maintained for a predetermined time in step 730.

When it is determined that the corresponding state is not maintained for a predetermined time, the process of step 710 is performed again.

When it is determined that the corresponding state is maintained for a predetermined time, the correction unit 230 corrects the offset value of the acceleration sensor in step 740. In a method of correcting the offset value of the acceleration sensor, for example, when the traveling velocity of the GPS data is 0 (zero) and the position information is fixedly maintained for a predetermined time (for example, 1 minute), the values of the acceleration sensor accumulated for a predetermined time (for example, 30 seconds) in the past are averaged and the average value is corrected into 0 (zero).

As described above, the acceleration sensor can be corrected using the GPS data.

The GPS data is slower in response than the sensor data, but the GPS data at a time when it can be generally considered as accurate data (for example, when the vehicle travels at a constant velocity or is parked) can be used to correct the acceleration sensor.

By the use of a mutual supplementation method of correcting the error of the GPS data using the sensor data, the value of the speedometer can be made to respond reliably, precisely, and rapidly.

The measured velocity correcting method may be carried out by a program installed in a user computer connected to the velocity measuring device with a cable.

For, example, in case of a vehicle black box, a dedicated viewer program for reproducing a stored video is used. The viewer program can accurately display the velocity at the reproducing time in the speedometer of the viewer program by frames by calculating the traveling velocity using the above-mentioned method on the basis of the sensor data of the acceleration sensor unit 220, the GPS position, and the velocity data which are stored in a specific area of video data to be reproduced or in a particularly file even when the vehicle black box does not have the velocity correcting function according to this embodiment.

The above-mentioned measured velocity correcting method may be carried out in time series by a software program built in the velocity measuring device. Codes and code segments of the program will be easily obtained by programmers skilled in the art. The program can be stored in a computer-readable recording medium and can be read and executed by a computer to embody the above-mentioned methods. The recording medium includes a magnetic recording medium, an optical recording medium, and a carrier wave medium.

While the invention has been described with reference to the exemplary embodiments, it will be understood by those skilled in the art that the invention can be modified and changed in various forms without departing from the spirit and scope of the invention described in the appended claims.

What is claimed is:

1. A velocity measuring device comprising:
a GPS unit that receives a satellite signal from a GPS (Global Positioning System) satellite and generates GPS data including position coordinates and a traveling velocity;
an acceleration sensor unit that includes an acceleration sensor and generates sensor data including a traveling velocity and a road slope; and
a correction unit that compares the GPS data and the sensor data generated at a current time with the GPS data and the sensor data generated at a previous time and sets the traveling velocity included in the sensor data or the GPS data as a measured velocity depending on whether a variation in traveling velocity exists.

2. The velocity measuring device according to claim 1, wherein the correction unit compares the GPS data and the sensor data generated at a current time with the GPS data and the sensor data generated at a previous time, sets the traveling velocity included in the sensor data as the measured velocity when a variation in traveling velocity exists in one or more of the GPS data and the sensor data, and sets the traveling velocity included in the GPS data as the measured velocity when a variation in traveling velocity does not exist.

3. The velocity measuring device according to claim 1, further comprising a storage unit that stores road slope correction ratios,
wherein the correction unit calculates the measured velocity by reading the correction ratio corresponding to the road slope included in the sensor data from the storage unit and applying the read correction ratio to the traveling velocity included in the GPS data.

4. The velocity measuring device according to claim 1, wherein the correction unit corrects an offset value of the acceleration sensor when one or more of the position coordinates and the traveling velocity included in the GPS data do not vary for a predetermined time.

5. The velocity measuring device according to claim 4, wherein the correction operation of the correction unit includes making the average of the traveling velocities in a predetermined number of generated sensor data be 0 (zero).

6. A velocity measuring device comprising:
a GPS unit that receives a satellite signal from a GPS (Global Positioning System) satellite and generates GPS data including position coordinates and a traveling velocity;
an acceleration sensor unit that includes an acceleration sensor and generates sensor data including a traveling velocity and a road slope; and
a correction unit that corrects an offset value of the acceleration sensor when one or more of the position coordinates and the traveling velocity included in the GPS data do not vary for a predetermined time.

7. The velocity measuring device according to claim 6, wherein the correction operation of the correction unit includes making the average of the traveling velocities in a predetermined number of generated sensor data be 0 (zero).

8. The velocity measuring device according to claim 6, wherein the correction unit compares the GPS data and the sensor data generated at a current time with the GPS data and the sensor data generated at a previous time, sets the traveling velocity included in the sensor data as the measured velocity when a variation in traveling velocity exists in one or more of the GPS data and the sensor data, and sets the traveling velocity included in the GPS data as the measured velocity when a variation in traveling velocity does not exist.

9. The velocity measuring device according to claim 6, further comprising a storage unit that stores road slope correction ratios,
wherein the correction unit calculates the measured velocity by reading the correction ratio corresponding to the road slope included in the sensor data from the storage unit and applying the read correction ratio to the traveling velocity included in the GPS data.

10. A measured velocity correcting method carried out by a velocity measuring device, comprising:
receiving a satellite signal from a GPS (Global Positioning System) satellite, generating GPS data including position coordinates and a traveling velocity, and generating sensor data including a traveling velocity and a road slope by the use of an acceleration sensor;
comparing the GPS data and the sensor data generated at a current time with the GPS data and the sensor data generated at a previous time and determining whether a variation in traveling velocity exists; and
setting the traveling velocity included in the sensor data as the measured velocity when a variation in traveling velocity exists in one or more of the GPS data and the sensor data and setting the traveling velocity included in the GPS data as the measured velocity when a variation in traveling velocity does not exist.

11. The measured velocity correcting method according to claim 10, further comprising a step of correcting the measured velocity by reading the correction ratio corresponding to the road slope included in the sensor data from the storage unit and applying the read correction ratio to the traveling velocity included in the GPS data.

12. The measured velocity correcting method according to claim 10, further comprising:
determining whether one or more of the position coordinates and the traveling velocity included in the GPS data vary for a predetermined time; and
correcting an offset value of the acceleration sensor when it is determined that one or more of the position coordinates and the traveling velocity included in the GPS data do not vary for a predetermined time.

13. The measured velocity correcting method according to claim 12, wherein the step of correcting an offset value includes making the average of the traveling velocities in a predetermined number of generated sensor data be 0 (zero).

14. A measured velocity correcting method carried out by a velocity measuring device, comprising:
receiving a satellite signal from a GPS (Global Positioning System) satellite, generating GPS data including position coordinates and a traveling velocity, and generating sensor data including a traveling velocity and a road slope by the use of an acceleration sensor;
determining whether one or more of the position coordinates and the traveling velocity included in the GPS data vary for a predetermined time; and
correcting an offset value of the acceleration sensor when it is determined that one or more of the position coordinates and the traveling velocity included in the GPS data do not vary for a predetermined time.

15. The measured velocity correcting method according to claim 14, wherein the step of correcting an offset value includes making the average of the traveling velocities in a predetermined number of generated sensor data be 0 (zero).

16. The measured velocity correcting method according to claim 14, further comprising the steps of
comparing the GPS data and the sensor data generated at a current time with the GPS data and the sensor data generated at a previous time and determining whether a variation in traveling velocity exists; and
setting the traveling velocity included in the sensor data as the measured velocity when a variation in traveling velocity exists in one or more of the GPS data and the sensor data and setting the traveling velocity included in the GPS data as the measured velocity when a variation in traveling velocity does not exist.

17. The measured velocity correcting method according to claim 14, further comprising a step of correcting the measured velocity by reading the correction ratio corresponding to the road slope included in the sensor data from the storage unit and applying the read correction ratio to the traveling velocity included in the GPS data.
